(19) United States
(12) Patent Application Publication
(10) Pub. No.: US 2013/0141646 A1
(43) Pub. Date: Jun. 6, 2013

(54) IMAGE DISPLAY DEVICE, IMAGE DISPLAY SYSTEM, AND CONTROL METHOD OF IMAGE DISPLAY DEVICE

(71) Applicant: Seiko Epson Corporation, Tokyo (JP)

(72) Inventor: Kenji Tanaka, Trondheim (NO)

(73) Assignee: SEIKO EPSON CORPORATION, Tokyo (JP)

(21) Appl. No.: 13/671,764

(22) Filed: Nov. 8, 2012

(30) Foreign Application Priority Data
Dec. 6, 2011 (JP) 2011-266545

(51) Int. Cl. H04N 9/31

(52) U.S. Cl. CPC H04N 9/31
USPC 348/569; 348/744

(57) ABSTRACT

With a projector, a user may confirm other content information such as music during image display. The projector is adapted to connect to a portable music reproducing player and a personal computer, and includes a sound output unit and an image display unit. The sound output unit performs sound output corresponding to a first content supplied from the portable music reproducing player. The image display unit that performs projection display of content information corresponding to the first content reproduced in the portable music reproducing player on an image corresponding to a second content supplied from the personal computer. Thereby, the projector displays the second content image and the content information corresponding to the first content.

### BACKGROUND

1. Technical Field

The present invention relates to an image display device, an image display system, a control method of the image display device, etc.

2. Related Art

Projectors as image display devices perform image output and sound output based on signals acquired from content reproducing devices such as personal computers connected to the projectors via signal cables or the like. Generally, the projector may output an image from one content reproducing device and sound in synchronization with the image at the same time. Further, this type of projector may output an image from one content reproducing device and sound from another content reproducing device at the same time.

For example, Patent Document 1 (JP-A-2011-128942) discloses a projector adapted for projection display of a captured image from a personal computer and output sound acquired from another content reproducing device than the personal computer. According to the projector, even when the personal computer displays the image nearly silently, the image may be displayed with additional music and sound effects and effective projection display of the captured image can be performed.

However, in the technology disclosed in Patent Document 1, there has been a problem that it may be impossible to confirm content information (for example, song title, reproduction time, or the like) of music or the like acquired from the other content reproducing device within the projected image during image display. Accordingly, it has been necessary for a user to visually confirm the display unit of the content reproducing device that reproduces the music or the like.

### SUMMARY

An advantage of some aspects of the invention is to solve at least a part of the problems described above, and the invention may be implemented as the following embodiments and modes.

(1) A first aspect of the invention is directed to an image display device adapted to connect to a first content reproducing device and a second content reproducing device including a sound output unit that performs sound output corresponding to a first content supplied from the first content reproducing device, and an image display unit that displays an image corresponding to a second content supplied from the second content reproducing device and content information corresponding to the first content.

According to this aspect of the invention, the content information corresponding to the first content reproduced in the first content reproducing device may be confirmed while the image of the second content from the second content reproducing device displayed by the image display device is viewed. Therefore, the image display device with which the user may confirm other content information such as music during image display may be provided. Thereby, it is not necessary for the user to confirm the content information corresponding to the first content by viewing the display unit of the first content reproducing device.

(2) A second aspect of the invention is directed to the image display device according to the first aspect of the invention, which further includes a communication control unit that performs communication control between the image display device and the first content reproducing device, wherein the communication control unit acquires the content information from the first content reproducing device.

According to this aspect of the invention, the content information of the first content is acquired from the first content reproducing device, and thus, the latest various content information corresponding to the first content may be reflected and displayed at the same time with the image of the second content.

(3) A third aspect of the invention is directed to the image display device according to the first aspect or the second aspect of the invention, which further includes an operation input unit that receives operation input to the image display device, wherein the image display unit switches between display and non-display of the content information in response to the operation input received by the operation input unit.

According to this aspect of the invention, the user may confirm the content information of the first content while viewing the image of the second content when necessary.

(4) A fourth aspect of the invention is directed to the image display device according to the third aspect of the invention, wherein the image display unit changes at least one of a character size of the content information, a display location of the content information, and an amount of information of the content information in response to the operation input received by the operation input unit, and displays the image corresponding to the second content and the content information at the same time.

According to this aspect of the invention, the user may confirm the content information corresponding to the first content reproduced in the first content reproducing device while viewing the image of the second content, for example, only the desired item of the content information in an easily visible manner for the user.

(5) A fifth aspect of the invention is directed to the image display device according to any one of the first aspect to the fourth aspect of the invention, which further includes an OSD control unit that generates an OSD image including the content information, wherein the image display unit displays the OSD image on the image corresponding to the second content.

According to this aspect of the invention, the content information corresponding to the first content may be confirmed while the image of the second content is viewed by very simple image generation processing with little processing load thereon.

(6) A sixth aspect of the invention is directed to the image display device according to any one of the first aspect to the fifth aspect of the invention, wherein the image display unit switches the content information to non-display after a predetermined time elapses from display of the content information.

According to this aspect of the invention, the troublesome operation for the user may be made unnecessary in addition to the above described advantage.

(7) A seventh aspect of the invention is directed to the image display device according to any one of the first aspect to the sixth aspect of the invention, wherein the content information includes at least one of an artist name, an album title, an image, a song title, a song file name, and a genre associated with the first content.

According to this aspect of the invention, at least one of the artist name, the album title, the image, the song title, the song file name, and the genre associated with the first content may be confirmed while the image of the second content is viewed.

(8) An eighth aspect of the invention is directed to the image display device according to any one of the first aspect to the seventh aspect of the invention, wherein the first content reproducing device is a portable music reproducing player.

According to this aspect of the invention, the content information corresponding to the first content reproduced in the portable music reproducing player frequently carried and used may be confirmed while the image of the second content displayed in the image display device is viewed.

A ninth aspect of the invention is directed to an image display system including the image display device according to any one of the first aspect to the eighth aspect, the first content reproducing device that reproduces the first content, and the second content reproducing device that reproduces the second content.

According to this aspect of the invention, the image display system with which the user may confirm the content information of the first content such as music during image display of the second content may be provided.

A tenth aspect of the invention is directed to a control method of an image display device adapted to connect to a first content reproducing device and a second content reproducing device including performing sound output corresponding to a first content supplied from the first content reproducing device, and displaying an image corresponding to a second content supplied from the second content reproducing device and content information corresponding to the first content.

According to this aspect of the invention, the content information corresponding to the first content reproduced in the first content reproducing device may be confirmed while the image of the second content from the second content reproducing device displayed by the image display device is viewed. Therefore, the control method of the image display device with which the user may confirm other content information such as music during image display may be provided. Thereby, it is not necessary for the user to confirm the content information corresponding to the first content by viewing the display unit of the first content reproducing device.

### BRIEF DESCRIPTION OF THE DRAWINGS

The invention will be described with reference to the accompanying drawings, wherein like numbers reference like elements.

FIG. 1 is a schematic diagram of a configuration example of an image display system according to one embodiment of the invention.

FIG. 2 is a block diagram of a configuration example of a projector in FIG. 1.

FIG. 3 is a flowchart of an operation example of the projector in the embodiment.

FIG. 4A shows one example of an image when a portable music reproducing player is selected as an image source. FIG. 4B shows one example of an image when the portable music reproducing player is selected as the image source during reproduction of a content.

FIG. 5 shows one example of an image displayed at step S5.

FIG. 6 shows one example of an image displayed at step S9.

FIG. 7A shows one example of an image when a character size of content information is changed to be larger. FIG. 7B shows one example of an image when the character size of the content information is changed to be smaller.

FIG. 8 shows one example of an OSD menu image in a second modified example of the embodiment.

FIG. 9A shows one example of an image when an amount of information of the content information is increased. FIG. 9B shows one example of an image when the amount of information of the content information is reduced.

FIG. 10A shows one example of an image when the content information including operation buttons is displayed. FIG. 10B shows one example of an image when the content information is displayed after operation input from the state of FIG. 10A.

FIG. 11A shows one example of an OSD menu image in a fourth modified example of the embodiment. FIG. 11B shows a state of changing a display location of the content information.

FIG. 12 shows one example of an image in a fifth modified example.

FIG. 13 shows one example of an image in a sixth modified example of the embodiment.

### DESCRIPTION OF EXEMPLARY EMBODIMENTS

Hereinafter, embodiments of the invention will be explained in detail using the drawings. Note that the embodiments explained as below do not unduly limit the subject matter of the invention described in the appended claims. Further, all of the configurations explained as below are not necessarily essential component elements of the invention.

### Image Display System

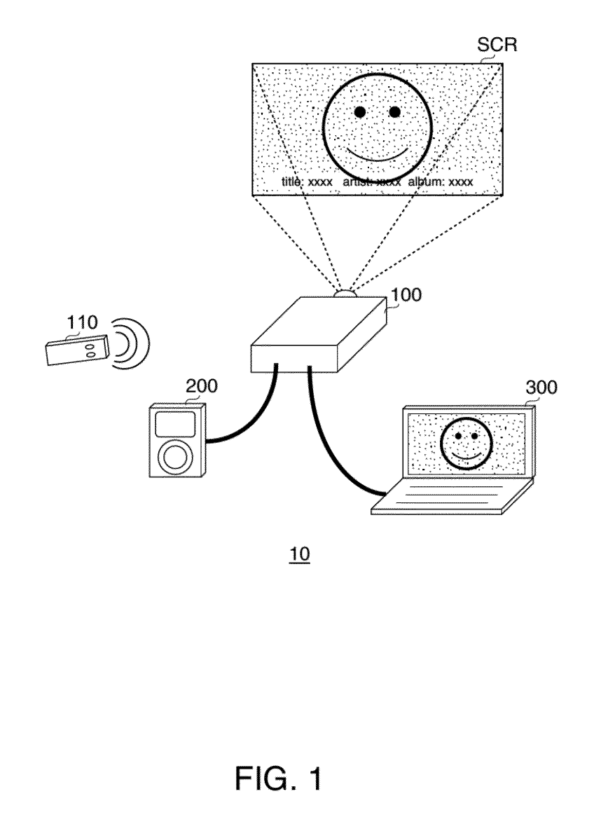

FIG. 1 is a schematic diagram of a configuration example of an image display system according to one embodiment of the invention.

An image display system 10 includes a projector (image display device) 100, a portable music reproducing player (first content reproducing device) 200, and a personal computer (second content reproducing device) 300. The projector 100 has a remote 110 for a user to be able to operate the projector 100 by operation input via the remote 110, for example. The portable music reproducing player 200 is connected to the projector 100 via a known signal cable, or a first connector included in the portable music reproducing player 200 and a second connector included in the projector 100 are directly connected. The personal computer 300 is connected to the projector 100 via a known signal cable.

The projector 100 may perform projection display of an image of a first content reproduced in the portable music reproducing player 200 on a screen SCR, and output sound of the first content. Further, the projector 100 may perform projection display of an image of a second content from the personal computer 300 on the screen SCR, and output sound of the second content.

Furthermore, the projector 100 may perform projection display of the image of the second content from the personal computer 300 on the screen SCR, and output the sound of the first content reproduced in the portable music reproducing player 200. Specifically, the projector 100 may output the image of the second content to be reproduced in the personal computer 300 and the sound of the first content to be reproduced in the portable music reproducing player 200 at the same time. In this regard, the projector 100 may perform projection display of content information corresponding to the first content being reproduced at the same time with the image of the second content on the screen SCR in response to the user's command via the remote 110 or the like. In the embodiment, as shown in FIG. 1, the projector 100 may perform projection display of content information corresponding to the first content being reproduced on the image of the second content on the screen SCR.

### Image Display Device

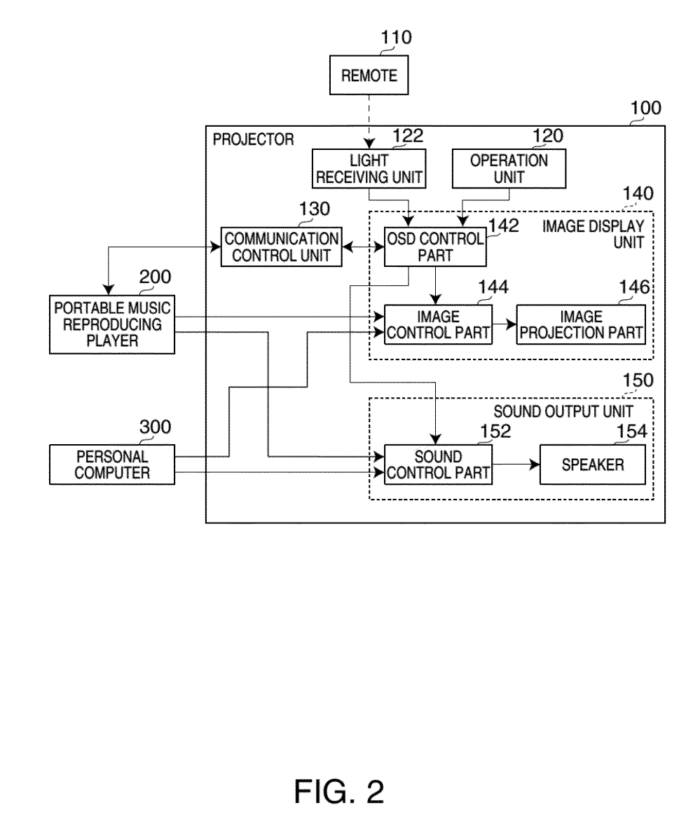

FIG. 2 shows a block diagram of a configuration example of the projector 100 in FIG. 1. In FIG. 2, the portable music reproducing player 200 and the personal computer (PC) 300 in FIG. 1 are shown together.

The projector 100 includes an operation unit 120, a light receiving unit 122, a communication control unit 130, an image display unit 140, and a sound output unit 150 in addition to the remote 110. The operation unit 120 functions as an operation input unit that receives operation input to the projector 100. The remote 110 and the light receiving unit 122 also function as the operation input unit. The image display unit 140 includes an OSD (On-Screen Display) control part 142, an image control part 144, an image projection part 146. The sound output unit 150 includes a sound control part 152 and a speaker 154.

The operation unit 120 is an operation panel provided on the projector 100, and outputs an operation command signal corresponding to the operation input by the user via the operation unit 120 to the OSD control part 142. The light receiving unit 122 receives a key code corresponding to the operation input by the user via the remote 110 and outputs an operation command signal corresponding to the key code to the OSC control part 142.

The communication control unit 130 controls communication between the portable music reproducing player 200 and itself, acquires content information existing within the portable music reproducing player 200, and outputs the information to the OSD control part 142. Further, the communication control unit 130 performs reproduction control of the portable music reproducing player 200 in response to the command from the OSD control part 142. Note that the reproduction control is control for execution of play, stop, pause, fast-forward, fast-rewind, etc. of the contents supplied to the projector 100.

The image display unit 140 performs projection display of the image of the content reproduced by the content reproducing device connected to the projector 100 on the screen SCR. Further, the image display unit 140 may perform projection display of the image corresponding to the second content from the personal computer 300 and the content information corresponding to the first content reproduced by the portable music reproducing player 200 on the screen SCR at the same time.

To the OSD control part 142, the operation command signal from the operation unit 120 or the light receiving unit 122 and the content information via the communication control unit 130 are input. The OSD control part 142 performs selection control of the image source controlled by the image control part 144 or the sound source controlled by the sound control part 152 based on the operation command signal. Specifically, the OSD control part 142 performs control of selecting one of the portable music reproducing player 200 and the personal computer 300 as the image source or the sound source, respectively, based on the operation command signal. Further, the OSD control part 142 performs reproduction control of the portable music reproducing player 200 with respect to the communication control unit 130. Furthermore, the OSD control part 142 generates an OSD image including superimposed content information or the like on the image supplied from the personal computer 300 selected as the image source, and outputs the image signal corresponding to the generated OSD image to the image control part 144.

The image control part 144 discriminates the image signal input from the portable music reproducing player 200 or the personal computer 300, performs image processing corresponding to the discriminated image signal, and outputs the image signal after image processing to the image projection part 146. Further, the image control part 144 selects one of the portable music reproducing player 200 and the personal computer 300 as the image source in response to the command from the OSD control part 142. Furthermore, the image control part 144 generates an image in which the OSD image generated by the OSD control part 142 is superimposed on the image from the selected image source, and outputs the image signal corresponding to the generated OSD image to the image projection part 146.

The image projection part 146 has an illumination system, a liquid crystal panel as a light modulation device, and a projection system. The illumination system applies illumination light to a panel surface of the liquid crystal panel. The liquid crystal panel is driven based on the image signal from the image control part 144, and an image corresponding to the image signal is formed on the panel surface. The illumination light applied to the panel surface is modulated in response to the image formed on the panel surface when being transmitted through the panel surface. The modulated illumination light is projected on the screen SCR by the projection system.

The sound output unit 150 outputs sound of the content to be reproduced by the content reproducing device connected to the projector 100. The sound control part 152 selects one of the portable music reproducing player 200 and the personal computer 300 as a sound source in response to the command from the OSD control part 142. The sound control part 152 outputs a signal corresponding to the sound from the selected sound source to the speaker 154. The speaker 154 performs sound output corresponding to the signal from the sound control part 152.

In the projector 100 having the configuration, it is assumed that the personal computer 300 is selected as the image source and the portable music reproducing player 200 is selected as the sound source. In this regard, the projector 100 may perform projection display of the content information corresponding to the content being reproduced in the portable music reproducing player 200 acquired via the communication control unit 130 as an image including the content information on the image from the personal computer 300 on the screen SCR. Thereby, the user may confirm the content information corresponding to the content of the portable music reproducing player 200 being reproduced while viewing the image from the personal computer 300 being reproduced as the projected image of the projector 100. Here, it is desirable that the content information includes at least one of an artist name, an album title, an image (artwork), a song title, a song file name, and a genre associated with the first content.

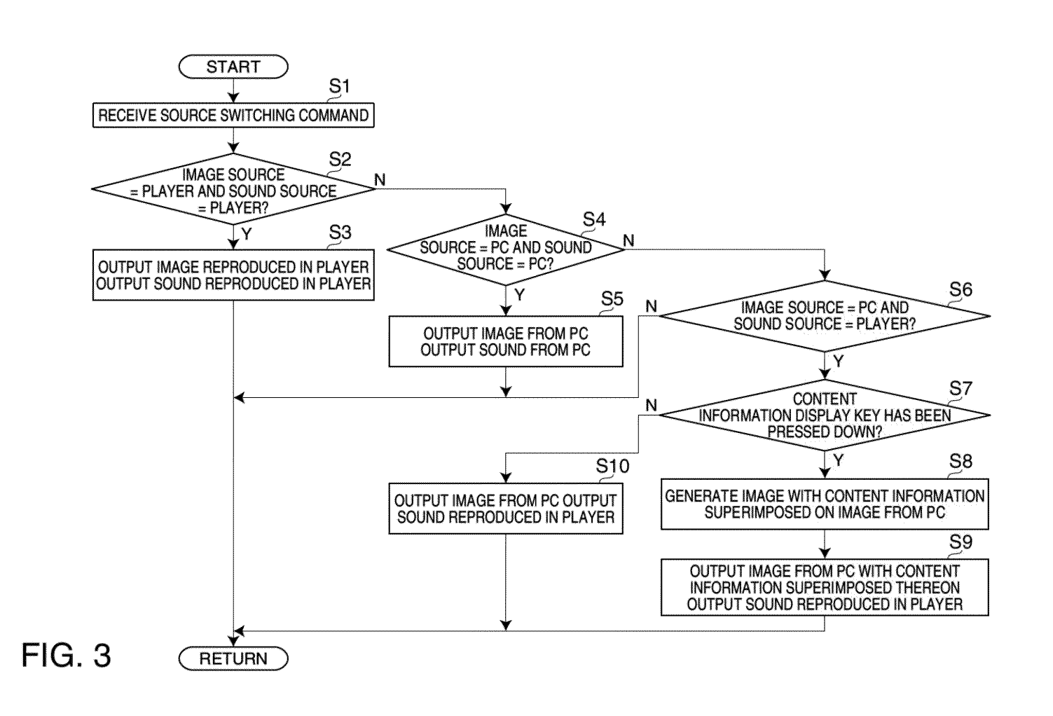

FIG. 3 shows a flowchart of an operation example of the projector 100 in the embodiment. In FIG. 3, the portable music reproducing player 200 is expressed by “player”, and the personal computer 300 is expressed by “PC”.

At step S1, the projector 100 receives a switching command between the image source and the sound source according to the operation input by the user via the remote 110 or the operation unit 120. The switching command by the user is sent to the OSD control part 142 as an operation command signal, and the OSD control part 142 performs selection control of the image source and the sound source based on the operation command signal.

Then, at step S2, whether or not the switching command according to the operation input from the user at step S1 is the command of selecting the portable music reproducing player 200 as the image source and the sound source is determined. If the switching command is the command of selecting the portable music reproducing player 200 as the image source and the sound source (step S2: Y), at step S3, the projector 100 selects the portable music reproducing player 200 as the image source and the sound source in the image control part 144 and the sound control part 152. Then, the projector 100 performs projection display of the image of the first content reproduced in the portable music reproducing player 200 on the screen SCR by the image projection part 146 and sound output of the sound of the first content by the speaker 154. Then, the projector 100 waits for the next command by the user (Return).

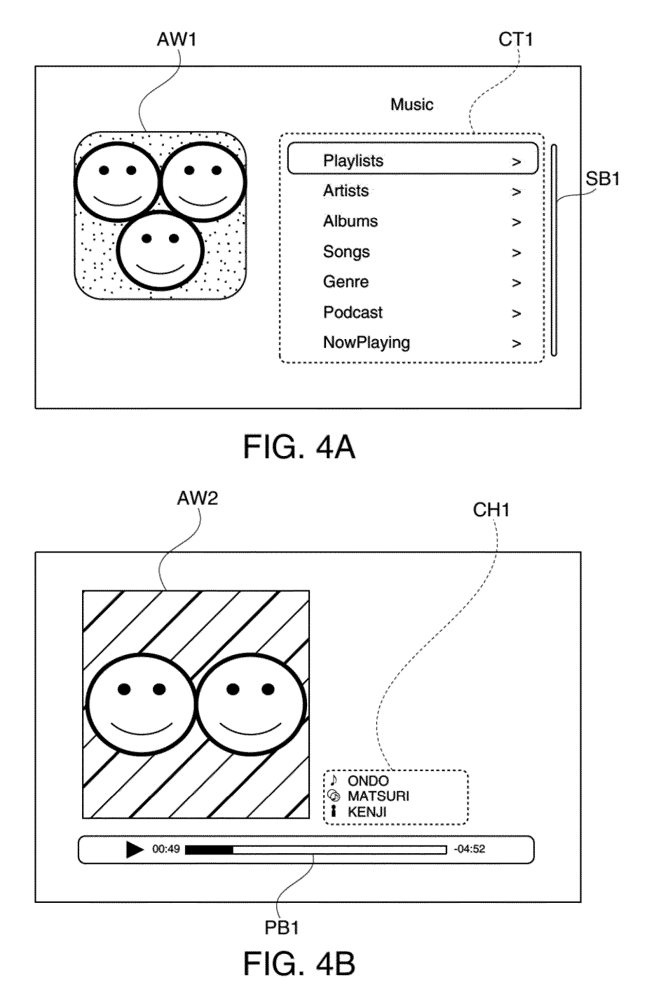

FIGS. 4A and 4B show one examples of images displayed on the projection screen by the projector 100 at step S3. FIG. 4A shows one example of an image when the portable music reproducing player 200 is selected as an image source. FIG. 4B shows one example of an image when the portable music reproducing player 200 is selected as the image source during reproduction of a content.

At step S3, for example, the images shown in FIGS. 4A and 4B generated in the portable music reproducing player 200 are displayed on the projection screen of the projector 100. In FIG. 4A, an artwork AW1 of the content selected in the portable music reproducing player 200 (an image corresponding to the content), a content list CT1, and a scroll bar SB1 for scrolling the contents of the content list CT1 are displayed. The content list CT1 includes playlists, artists, albums, song titles, genres, podcasts including sound data published on the network, and content information corresponding to the content being currently reproduced. In FIG. 4B, an artwork AW2 of the content being reproduced in the portable music reproducing player 200, content information CH1 corresponding to the content being reproduced, and a progress bar PB1 showing the reproduction status of the content are displayed. Here, the artwork is the image corresponding to the first content reproduced by the portable music reproducing player 200 (for example, a jacket image of a CD album). As the content information CH1, the song title, the album title, and the artist name are displayed.

In FIG. 3, at step S2, if the switching command according to the operation input from the user is not the command of selecting the portable music reproducing player 200 as the image source and the sound source (step S2: N), the process moves to step S4.

Then, at step S4, whether or not the switching command according to the operation input from the user at step S1 is the command of selecting the personal computer 300 as the image source and the sound source is determined. If the switching command is the command of selecting the personal computer 300 as the image source and the sound source (step S4: Y), at step S5, the projector 100 selects the personal computer 300 as the image source and the sound source in the image control part 144 and the sound control part 152. Then, the projector 100 performs projection display of the image of the second content reproduced in the personal computer 300 on the screen SCR by the image projection part 146 and sound output of the sound of the second content by the speaker 154. Then, the projector 100 waits for the next command by the user (Return).

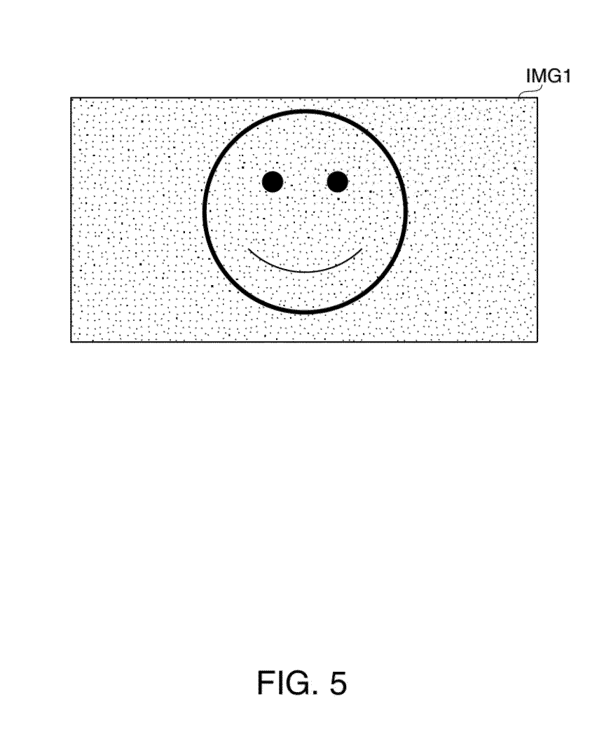

FIG. 5 shows one example of an image displayed on the projection screen by the projector 100 at step S5. FIG. 5 shows one example of an image when the personal computer 300 is selected as the image source.

At step S5, for example, the image IMG1 shown in FIG. 5 generated in the personal computer 300 is projected by the projector 100. Then, the projector 100 performs projection of the image IMG1 and also output of the sound reproduced in the personal computer 300.

In FIG. 3, at step S4, if the switching command according to the operation unit from the user is not the command of selecting the personal computer 300 as the image source and the sound source (step S4: N), the process moves to step S6.

Then, at step S6, whether or not the switching command according to the operation input from the user at step S1 is the command of selecting the personal computer 300 as the image source and selecting the portable music reproducing player 200 as the sound source is determined. If the switching command is the command of selecting the personal computer 300 as the image source and selecting the portable music reproducing player 200 as the sound source (step S6: Y), the projector 100 selects the personal computer 300 as the image source in the image control part 144 and selects the portable music reproducing player 200 as the sound source in the sound control part 152.

Then, at step S7, the projector 100 detects whether or not a content information display key assigned in advance in the remote 110 or the operation unit 120 has been pressed down. If the pressing down of the content information display key is detected (step S7: Y), the projector 100 first generates an OSD image using the content information of the first content acquired via the communication control unit 130 that communicates with the portable music reproducing player 200 (first content reproducing device) in the OSD control part 142. Note that the content information of the first content is acquired by the communication control unit 130 before the sound output from the portable music reproducing player 200 connected to the projector 100. Thereby, the OSD image reflecting the latest various content information corresponding to the first content may be generated.

Then, at step S8, the projector 100 generates an image in which the OSD image reflecting the content information corresponding to the first content is superimposed on the image (second content) from the personal computer 300 (second content reproducing device) in the image control part 144.

Then, at step S9, the projector 100 performs projection of the image in which the OSD image is superposed on the image of the second content from the personal computer 300 on the screen SCR by the image projection part 146 and sound output of the sound of the first content by the speaker 154. That is, step S9 may include a sound output step and an image display step. At the sound output step, sound output corresponding to the first content from the portable music reproducing player 200 is performed. At the image display step, the image corresponding to the second content from the personal computer 300 and the content information corresponding to the first content are displayed. Then, the projector 100 waits for the next command by the user (Return).

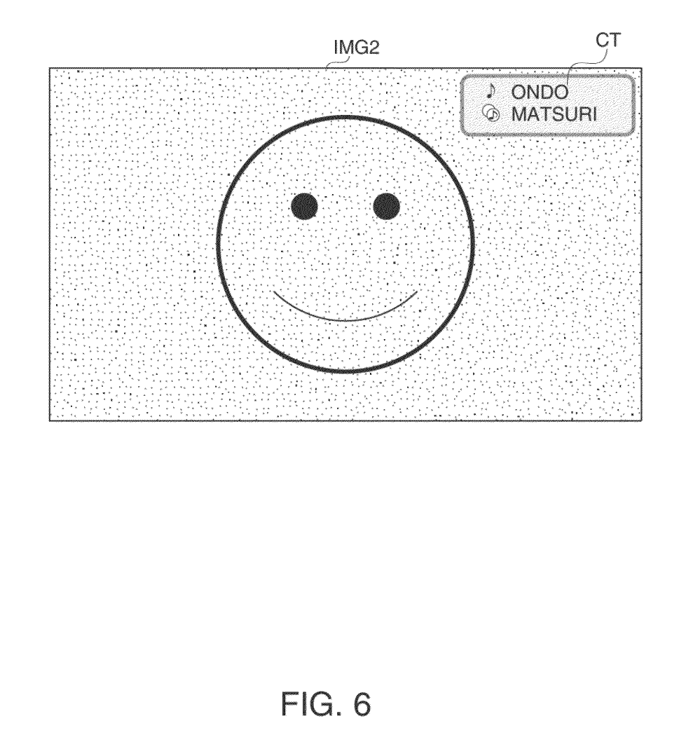

FIG. 6 shows one example of an image displayed on the projection screen by the projector 100 at step S9. FIG. 6 shows an image in which the content information CH1 of the first content generated in the portable music reproducing player 200 of FIG. 4B is superimposed on the image IMG1 generated in the personal computer 300 in FIG. 5, for example.

The OSD control part 142 generates an OSD image CT using the content information of the first content acquired via the communication control unit 130 as described above. The image control part 144 generates an image IMG2 in which the OSD image CT is superimposed on the image IMG1 in FIG. 5 in a predetermined location, for example, and the image projection part 146 projects the image IMG2 on the screen SCR.

Note that it is desirable that, regarding the OSD image CT including the content information of the first content displayed at step S9, the OSD image CT is displayed on the image IMG2, and then, not displayed after a predetermined time elapses. In this manner, by switching the display of the content information on the image of the second content to the non-display after the predetermined time elapses, the troublesome operation for the user may be made unnecessary.

Further, it is desirable that the projector 100 switches display and non-display of the content information corresponding to the first content in response to the user's operation input via the remote 110 or the operation unit 120 as the operation input unit. In the embodiment, display/non-display of the content information may be switched by pressing down of the content information display key.

In FIG. 3, at step S7, if the pressing down of the content information display key is not detected (step S7: N), at step S10, the projector 100 projects the image of the second content from the personal computer 300 on the screen SCR and outputs the sound of the first content from the portable music reproducing player 200. Then, the projector 100 waits for the next command by the user (Return).

Here, at step S6, if the switching command according to the operation input from the user at step S1 is not the command of selecting the personal computer 300 as the image source or selecting the portable music reproducing player 200 as the sound source (step S6: N), the projector 100 stops the projection display and the sound output, and waits for the next command by the user (Return).

As explained above, in the embodiment the projector 100 adapted to connect to the portable music reproducing player 200 and the personal computer 300 operates in the following manner. That is, the projector 100 acquires the first content and the content information corresponding to the first content from the portable music reproducing player 200, and generates the OSD image with respect to the content information. Then, the projector 100 may display the image of the second content from the personal computer 300 and the OSD image including the content information corresponding to the first content being reproduced by the portable music reproducing player 200. Thereby, the user may confirm the content information corresponding to the first content reproduced in the portable music reproducing player 200 while viewing the image from the personal computer 300 projected by the projector 100.

### FIRST MODIFIED EXAMPLE

In the embodiment, the character size of the content information displayed on the image from the personal computer 300 may be changed through the operation input by the user via the remote 110 or the operation unit 120.

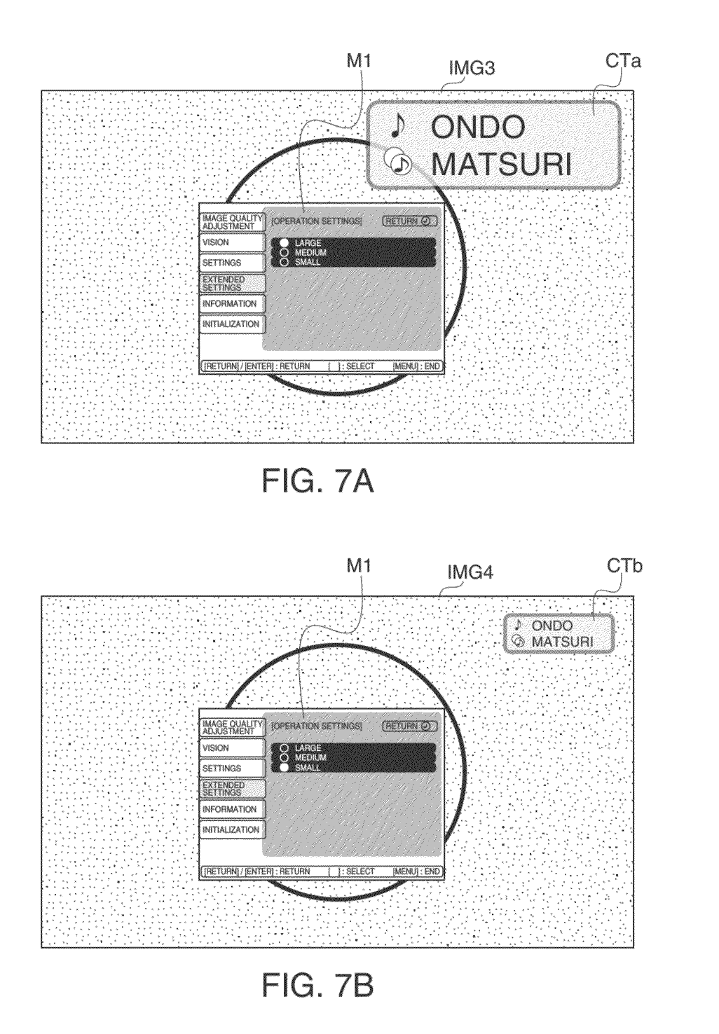

FIGS. 7A and 7B show one examples of images in a first modified example of the embodiment. FIG. 7A shows one example of an image when the character size of the OSD image CT (FIG. 6) including the content information is changed to be larger. FIG. 7B shows one example of an image after change when the character size of the OSD image CT (FIG. 6) including the content information is changed to be smaller.

The user presses down a menu display key assigned in advance in the remote 110 or the operation unit 120, and thereby, the projector 100 displays an OSD menu image M1 generated by the OSD control part 142. In the OSD menu image M1, items for designating the character size are provided in a predetermined setting item such as “EXTENDED SETTINGS”, for example.

In the first modified example, the character size may be selected among “LARGE”, “MEDIUM”, and “SMALL”. When the character size is set to “LARGE”, for example, through the operation input by the user via the remote 110 or the operation unit 120, the OSD control part 142 generates an OSD image CTa including content information with the character size set to “LARGE” as shown in FIG. 7A. The OSD control part 142 changes the size of the display area of the OSD image CTa in response to the set character size.

Further, when the character size is set to “SMALL”, for example, through the operation input by the user via the remote 110 or the operation unit 120, the OSD control part 142 generates an OSD image CTb including content information with the character size set to “SMALL” as shown in FIG. 7B. The OSD control part 142 changes the size of the display area of the OSD image CTb in response to the set character size.

In the first modified example, the projector 100 projects an image IMG3 or an image IMG4 in which the OSD image CTa or the OSD image CTb generated in the above described manner is superimposed on the image IMG1 from the personal computer 300 as shown in FIG. 5, for example. Note that FIGS. 7A and 7B show one examples of the images when the menu image M1 is displayed on the images IMG3, IMG4.

According to the first modified example, the user may confirm the content information corresponding to the first content reproduced in the portable music reproducing player 200 while viewing the image from the personal computer 300 projected by the projector 100 in an easily visible manner for the user.

### SECOND MODIFIED EXAMPLE

In the embodiment or the modified example, the amount of information of the content information displayed on the image from the personal computer 300 maybe increased or reduced through the operation input by the user via the remote 110 or the operation unit 120.

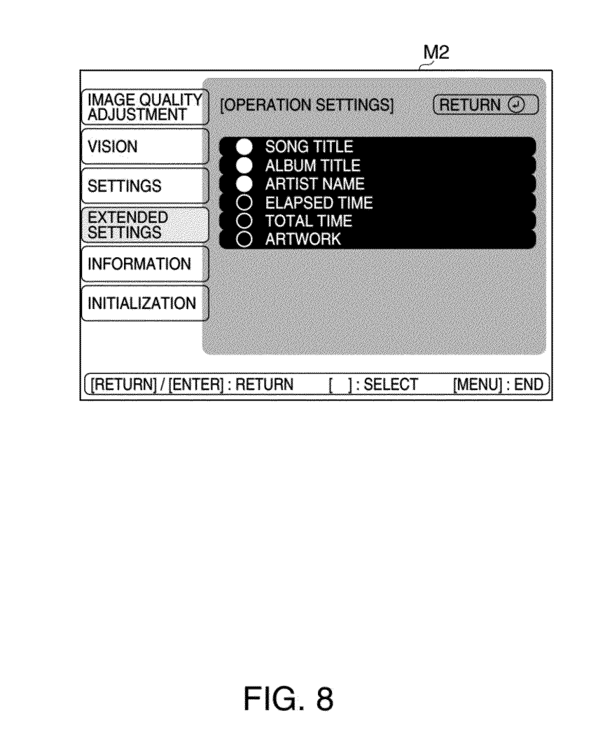

FIG. 8 shows an image of the OSD menu image in a second modified example of the embodiment.

The user presses down a menu display key assigned in advance in the remote 110 or the operation unit 120, and thereby, an OSD menu image M2 generated by the OSD control part 142 is displayed. In the OSD menu image M2, items for designating the displayed information of the displayable content information are provided in a predetermined setting item such as “EXTENDED SETTINGS”, for example.

In the second modified example, the content information includes “song title”, “album title”, “artist name”, “elapsed time”, “total time”, and “artwork”. FIG. 8 shows one example of the OSD menu image when “song title”, “album title”, and “artist name”, for example, are designated through the operation input by the user via the remote 110 or the operation unit 120.

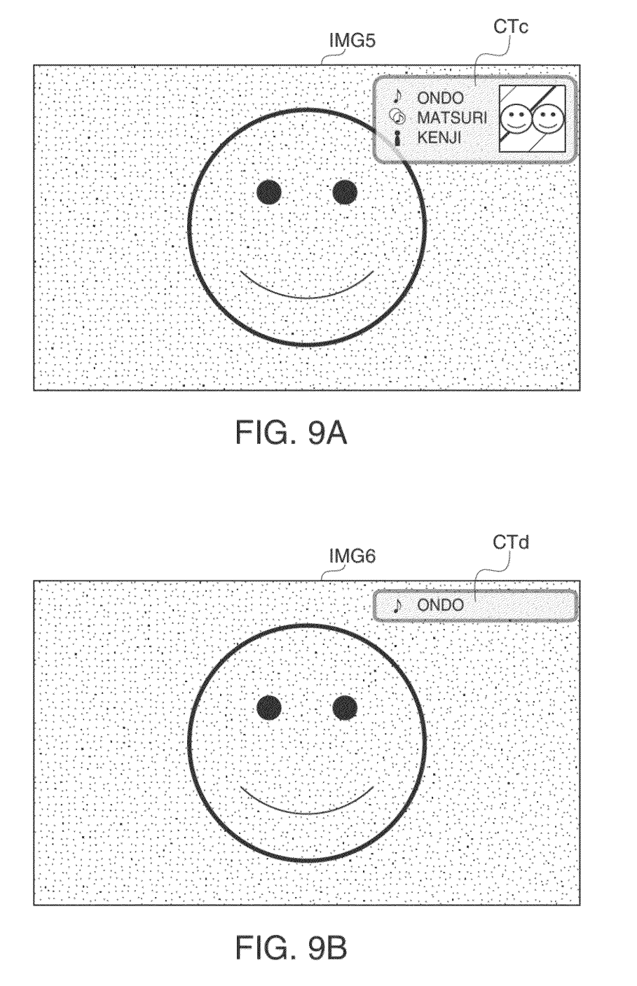

FIGS. 9A and 9B show one examples of images in the second modified example. FIG. 9A shows one example of an image when the amount of information of the OSD image CT (FIG. 6) including the content information is increased. FIG. 9B shows one example of an image when the amount of information of the OSD image CT (FIG. 6) including the content information is reduced.

From the status in FIG. 6, the OSD menu image M2 of FIG. 8 is displayed, and “song title”, “album title”, “artist name”, and “artwork”, for example, are designated through the operation input by the user. In this regard, the OSD control part 142 generates an OSD image CTc including content information as shown in FIG. 9A. Further, from the status in FIG. 6, the OSD menu image M2 of FIG. 8 is displayed, only “song title”, for example, is designated through the operation input by the user, and then, the OSD control part 142 generates an OSD image CTd including content information as shown in FIG. 9B.

In the second modified example, the projector 100 projects an image IMG5 or an image IMG6 in which the OSD image CTc or the OSD image CTd generated in the above described manner is superimposed on the image IMG1 from the personal computer 300 as shown in FIG. 5, for example.

According to the second modified example, the user may confirm only the desired item of the content information corresponding to the first content reproduced in the portable music reproducing player 200 while viewing the image from the personal computer 300 projected by the projector 100.

### THIRD MODIFIED EXAMPLE

In the embodiment or the modified examples, operation buttons that enable reproduction control of the portable music reproducing player 200 may be displayed on the image from the personal computer 300 through the operation input by the user via the remote 110 or the operation unit 120.

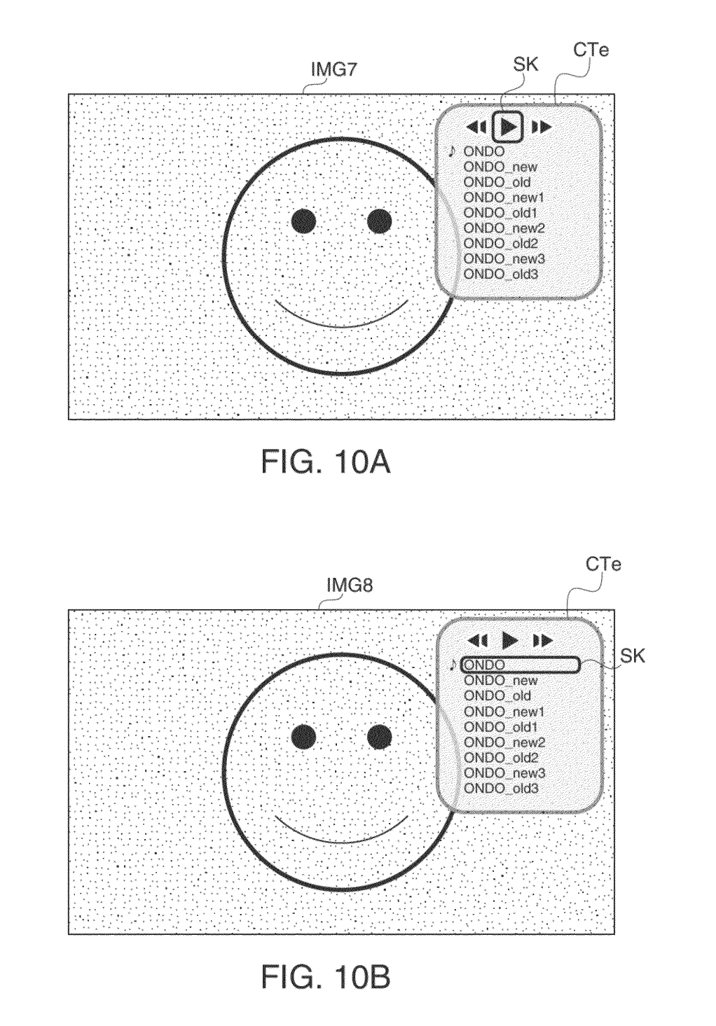

FIGS. 10A and 10B show one examples of images in a third modified example. FIG. 10A shows one example of an image in which content information including operation buttons is displayed. FIG. 10B shows one example of an image in which the content information after operation input using the operation buttons from the status of FIG. 10A.

The OSD control part 142 generates an OSD image CTe including the content information including the operation buttons for reproduction control of the portable music reproducing player 200 in addition to the content information corresponding to the first content reproduced by the portable music reproducing player 200. The content information includes a playlist. The operation buttons include a play button also having a function of a pause button, a fast-forward button also having a function of a forward button, a fast-rewind button also having a function of a rewind button.

As shown in FIG. 10A, in the OSD image CTe including the content information, a selection frame SK is movable through the operation input by the user via the remote 110 or the operation unit 120. By pressing down the enter key, reproduction control corresponding to the operation button surrounded by the selection frame SK or selection of the content is performed. Here, when a down arrow key is pressed down by the remote 110 or the operation unit 120, the selection frame SK moves downward as shown in FIG. 10B, and the OSD control part 142 generates the OSD image CTe in which the selection frame SK is displayed in a location surrounding the top song in the playlist.

In the third modified example, the projector 100 projects an image IMG7 or an image IMG8 in which the OSD image CTe generated in the above described manner is superimposed on the image IMG1 from the personal computer 300 as shown in FIG. 5, for example.

According to the third modified example, the user may perform the reproduction control of the portable music reproducing player 200 while viewing the projected image without viewing the operation unit of the portable music reproducing player 200 in addition to the advantage of the embodiment.

### FOURTH MODIFIED EXAMPLE

In the embodiment or the modified examples, the display location of the content information displayed on the image from the personal computer 300 may be changed through the operation input by the user via the remote 110 or the operation unit 120.

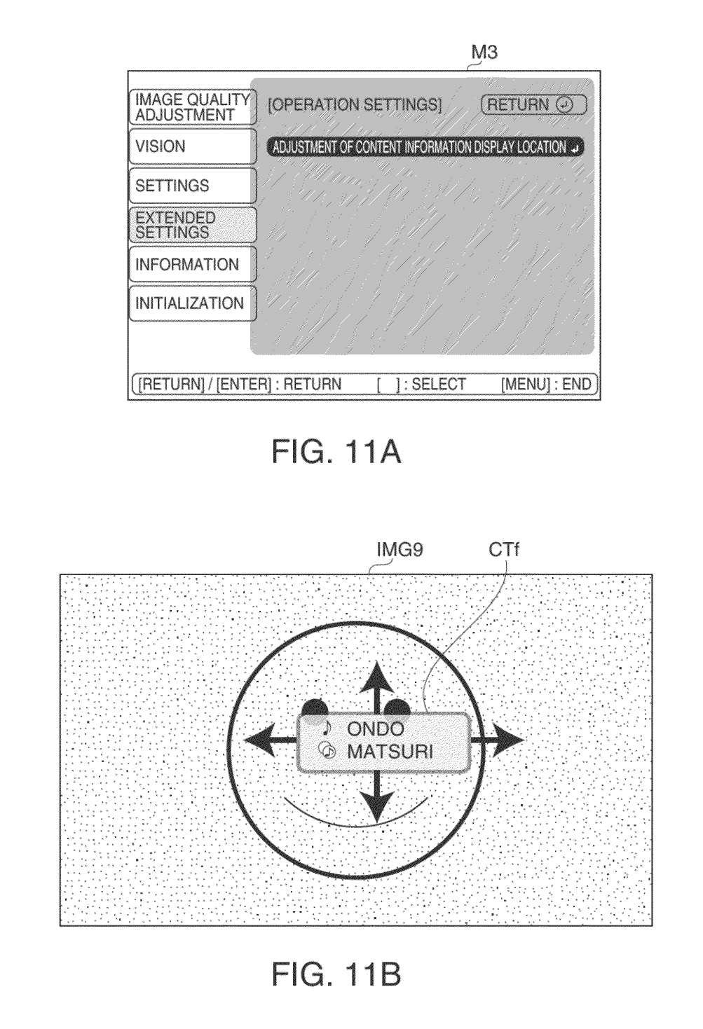

FIGS. 11A and 11B show one examples of images in a fourth modified example of the embodiment. FIG. 11A shows one example of the OSD menu image in the fourth modified example. FIG. 11B shows changes of the display location of the content information.

The user presses down a menu display key assigned in advance in the remote 110 or the operation unit 120, and thereby, the projector 100 displays an OSD menu image M3 generated by the OSD control part 142. In the OSD menu image M3, items for designating the display location of the content information are provided in a predetermined setting item such as “EXTENDED SETTINGS”, for example. When the user designates the display location of the content information by pressing down of the enter key, the image control part 144 performs projection display of an image IMG9 in which an OSD image CTf including the content information is superimposed on the image from the personal computer 300 by the image projection part 146. Regarding the OSD image CTf including the content information, the display location is adjustable using the direction keys of the remote 110 or the operation unit 120, and the display location is fixed using the enter key. The fixed display location is saved in the OSD control part 142, and then, when the OSD image including the content information is displayed, the image is displayed in the fixed display location.

Note that it is not necessary to change the display location of the content information via the OSD menu image M3. For example, the display location may be made adjustable as shown in FIG. 11B by pressing and holding the content information display key in a fixed time during display of the content information.

According to the fourth modified example, the user may confirm the content information in the location easily visible for the user in addition to the advantage of the embodiment.

### FIFTH MODIFIED EXAMPLE

In the embodiment or the modified examples, the explanation that the portable music reproducing player 200 displays the content information corresponding to the first content being reproduced on the image from the personal computer 300 has been made, not limited to that.

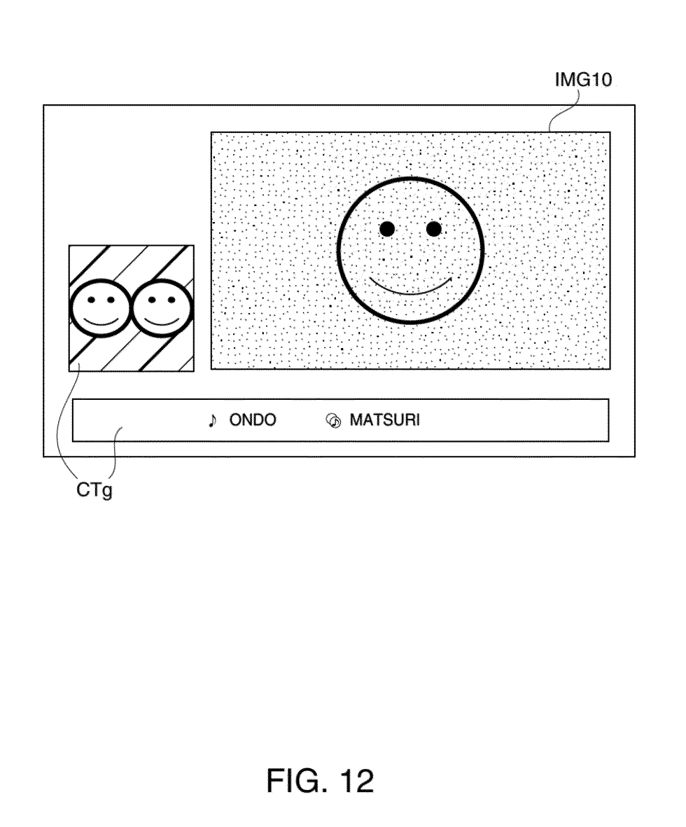

FIG. 12 shows one example of an image in a fifth modified example of the embodiment.

In the fifth modified example, the OSD control part 142 generates an OSD image CTg using content information of the first content acquired via the communication control unit 130. Further, the image control part 144 projects an image in which an image IMG10 formed by reducing the display size of the image from the personal computer 300 and the OSD image CTg on the screen SCR by the image projection part 146.

Note that the respective display locations of the OSD image CTg, the image IMG10 are not limited to those shown in FIG. 12 as long as the OSD image CTg is displayed without overlapping with the image IMG10.

According to the fifth modified example, the content information may be displayed in the location not blocking the vision of the image from the personal computer 300 in addition to the advantage of the embodiment. Thereby, the user may reliably confirm the content information without damaging the visibility of the image from the personal computer 300.

### SIXTH MODIFIED EXAMPLE

In the embodiment or the modified examples, for example, an example in which the content information is displayed near the lower side of the image from the personal computer 300 has been explained, however, not limited to that.

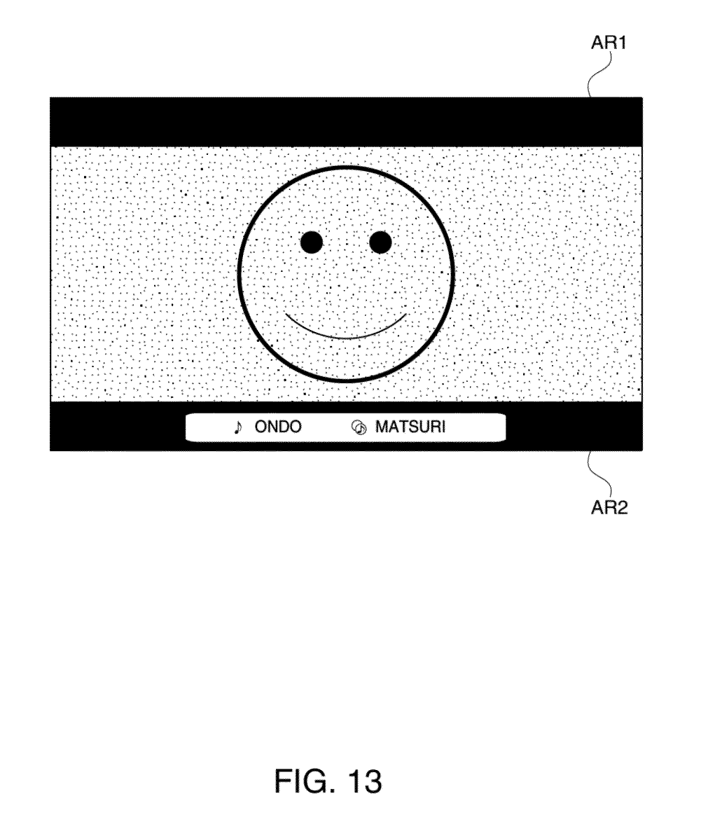

FIG. 13 shows one example of an image in a sixth modified example of the embodiment.

In the sixth modified example, the OSD control part 142 or the image control part 144 analyzes the image from the personal computer 300 and detects an area in which the difference in gray level between pixels adjacent to each other is the predetermined amount or small. For example, in FIG. 13, the OSD control part 142 or the image control part 144 may have a black area detection part and the black area detection part may detect areas AR1, AR2 having predetermined or larger sizes in black representation. Then, the image control part 144 generates an image so that an OSD image including content information may be superimposed on the area AR2 of the detected areas AR1, AR2, and performs projection display of the image on the screen SCR by the image projection part 146.

According to the sixth modified example, like the fifth modified example, the content information may be displayed in the location not blocking the vision of the image from the personal computer 300. Thereby, the user may reliably confirm the content information without damaging the visibility of the image from the personal computer 300.

As above, the image display device, the image display system, the control method of the image display device, etc. according to the embodiments of the invention have been explained according to the embodiment or the modified examples, however, the invention is not limited to the embodiment or the modified examples. For example, the invention can be implemented in various modes without departing from the scope thereof, and the following modifications can be made.

(1) In the embodiment or the modified examples thereof, the projector has been explained as an example as the image display device according to the invention, however, the invention is not limited to it. As the image display device according to the invention, any device that displays an image may be used. For example, a rear projection television, a liquid crystal television, a plasma display, or the like may be used.

(2) In the embodiment or the modified examples thereof, the configuration in which the image projection part 146 according to the invention employs the liquid crystal panel as the light modulation device has been explained, however, the invention is not limited to it. The image projection part 146 according to the invention may have a configuration in which a digital micromirror device used in the DMD (Digital Micromirror Device) system is employed as the light modulation device instead of the liquid crystal panel such as a transmissive reflective liquid crystal panel or a reflective liquid crystal panel used in an LCOS (Liquid Crystal On Silicon) system or the like.

(3) In the embodiment or the modified examples thereof, the explanation that the user performs operation input mainly via the remote 110 has been made, however, the invention is not limited to that.

(4) In the modified examples of the embodiment, the explanation that at least one of the size of the display area of the content information, the display location of the content information, and the amount of information of the content information is changed in response to the operation input by the user has been made, however, the invention is not limited to that. For example, the size and shape of the display area of the content information, the display locations and arrangements of characters and images of the content information may be individually changed.

(5) In the embodiment or the modified examples thereof, the portable music reproducing player has been explained as an example of the first content reproducing device, however, the invention is not limited to that. As the first content reproducing device according to the invention, a device that performs sound output may be employed.

(6) In the embodiment or the modified examples thereof, the personal computer has been explained as an example of the second content reproducing device, however, the invention is not limited to that. As the second content reproducing device according to the invention, a device that performs image output may be employed.

(7) In the embodiment or the modified examples thereof, mainly, the example in which the content information of the first content is displayed in the lateral direction (horizontal direction) has been explained, however, the invention is not limited to that. For example, the content information of the first content may be displayed in the longitudinal direction (vertical direction).

(8) In the embodiment or the modified examples thereof, the above described functions may be realized using only hardware or a combination of hardware and software. Further, the image display device may include at least one of the first content reproducing device and the second content reproducing device.

(9) In the embodiment or the modified examples thereof, the invention has been explained as the image display device, the image display system, the control method of the image display device, etc., however, the invention is not limited to those. For example, a program in which processing procedures of the control method of the image display device according to the invention is described or a recording medium in which the program is recorded may be employed.

The entire disclosure of Japanese Patent Application No. 2011-266545, filed Dec. 6, 2011 is expressly incorporated by reference herein.

What is claimed is:

1. An image display device adapted to connect to a first content reproducing device and a second content reproducing device, comprising:
a sound output unit that performs sound output corresponding to a first content supplied from the first content reproducing device; and
an image display unit that displays an image corresponding to a second content supplied from the second content reproducing device and content information corresponding to the first content.

2. The image display device according to claim 1, further comprising a communication control unit that performs communication control between the image display device and the first content reproducing device,
wherein the communication control unit acquires the content information from the first content reproducing device.

3. The image display device according to claim 1, further comprising an operation input unit that receives operation input to the image display device,
wherein the image display unit switches between display and non-display of the content information in response to the operation input received by the operation input unit.

4. The image display device according to claim 3, wherein the image display unit changes at least one of a character size of the content information, a display location of the content information, and an amount of information of the content information in response to the operation input received by the operation input unit, and displays the image corresponding to the second content and the content information.

5. The image display device according to claim 1, further comprising an OSD control unit that generates an OSD image including the content information,
wherein the image display unit displays the OSD image on the image corresponding to the second content.

6. The image display device according to claim 1, wherein the image display unit switches the content information to non-display after a predetermined time lapses from display of the content information.

7. The image display device according to claim 1, wherein the content information includes at least one of an artist name, an album title, an image, a song title, a song file name, and a genre associated with the first content.

8. The image display device according to claim 1, wherein the first content reproducing device is a portable music reproducing player.

9. An image display system comprising:
the image display device according to claim 1;
the first content reproducing device that reproduces the first content; and
the second content reproducing device that reproduces the second content.

10. An image display system comprising:
the image display device according to claim 2;
the first content reproducing device that reproduces the first content; and
the second content reproducing device that reproduces the second content.

11. An image display system comprising:
the image display device according to claim 3;
the first content reproducing device that reproduces the first content; and
the second content reproducing device that reproduces the second content.

12. An image display system comprising:
the image display device according to claim 4;
the first content reproducing device that reproduces the first content; and
the second content reproducing device that reproduces the second content.

13. An image display system comprising:
the image display device according to claim 5;
the first content reproducing device that reproduces the first content; and
the second content reproducing device that reproduces the second content.

14. An image display system comprising:
the image display device according to claim 6;
the first content reproducing device that reproduces the first content; and
the second content reproducing device that reproduces the second content.

15. An image display system comprising:
the image display device according to claim 7;
the first content reproducing device that reproduces the first content; and
the second content reproducing device that reproduces the second content.

16. An image display system comprising:
the image display device according to claim 8;
the first content reproducing device that reproduces the first content; and
the second content reproducing device that reproduces the second content.

17. A control method of an image display device adapted to connect to a first content reproducing device and a second content reproducing device, comprising:
performing sound output corresponding to a first content supplied from the first content reproducing device; and
displaying an image corresponding to a second content supplied from the second content reproducing device and content information corresponding to the first content.
